(19) United States
(12) Patent Application Publication
(10) Pub. No.: US 2024/0036858 A1
(43) Pub. Date: Feb. 1, 2024

(54) Dataflow Pipeline Deployment System and Method

(71) Applicant: Constant Contact, Inc., Waltham, MA (US)

(72) Inventors: Srinivasa Subramanyam Pulugurtha, Nashua, NH (US); Pritish Prashant Pai, Natick, MA (US); Misha Smirnov, Andover, MA (US); Juan Yin, Lexington, MA (US)

(21) Appl. No.: 18/227,832

(22) Filed: Jul. 28, 2023

Related U.S. Application Data
(60) Provisional application No. 63/369,664, filed on Jul. 28, 2022.

(51) Int. Cl. G06F 8/71; G06F 8/65

(52) U.S. Cl. CPC G06F 8/71; G06F 8/65

(57) ABSTRACT

A computer-based method for managing a dataflow pipeline across a plurality of environments, includes the steps of: receiving, for a first environment, a check-in comprising source code, a task definition, a configuration, and a flow definition; receiving a definition of an application secret and an associated credential; storing the application secret and credential in a dataflow pipeline deployer data store; creating a data flow pipeline package, further comprising the steps of: merging the source code, the configuration, and the secrets; and defining a pipeline graph in the first environment pipeline flow registry.

### CROSS-REFERENCE TO RELATED APPLICATIONS

The present application claims priority to U.S. provisional patent application No. 63/369,664, entitled “Dataflow Pipeline Deployment Method”, filed on Jul. 28, 2022, which is incorporated herein by reference in its entirety.

### FIELD OF THE INVENTION

The present invention relates to continuous integration and continuous delivery (CI/CD) software development tools, and more particularly, is related to in-service software updates.

### BACKGROUND OF THE INVENTION

Availability of computer programs is essential to many businesses. A business may lose valuable time during software updates for mission critical programs. For example, large, distributed software applications may include multiple processes that may each have their own development schedules, which can lead to frequent outages while the various processes are updated. Further, dependencies across components may be complex, for example, if updating a first process requires additional updates to upstream and/or downstream processes. Typically, updating of any one component in a multi-component system results in downtime for the entire system.

For example, a developer implements a change by making a working copy (“branch”) of the current code base, updating the code in a snapshot of the code base at one moment in time. As other developers submit changed code to the source code repository, this snapshot ceases to reflect the (live) repository code. As the existing code base changes, new code may also be added, as well as new libraries, and other resources that create dependencies, and potential conflicts. The longer development continues on a branch without merging back to the mainline, the greater the risk of multiple integration conflicts and failures when the developer branch is eventually merged back. When developers submit code to the repository, they must first update their code to reflect the changes in the repository since they took their copy. The more changes the repository contains, the more work developers must do before submitting their own changes.

Therefore, there is a need in the industry to address the abovementioned shortcomings.

### SUMMARY OF THE INVENTION

The present system and method provides a dataflow pipeline deployment system and method. A computer based software development system is configured to deploy a plurality of package environments, comprising: a processor and storage device configured to store non-transient instructions that when implemented by the processor comprise: a dataflow pipeline deployer (110); a Git repository (120) configured to store a flow definition and an environment specific parameter; a secret store (125) configured to store an API key/secret and data pipeline credentials; and for each environment of the plurality of environments: a pipeline flow registry (140, 170) configured to store a static definition (151, 181) of an environment specific production dataflow pipeline (152, 182); a dataflow pipeline container (150, 180) configured to contain the production dataflow pipeline and a store (154, 184) of environment specific secrets and parameters.

A computer-based method for managing a dataflow pipeline across a plurality of environments, is also provided, comprising the steps of: receiving, for a first environment, a check-in comprising source code, a task definition, a configuration, and a flow definition; receiving a definition of an application secret and an associated credential; storing the application secret and credential in a dataflow pipeline deployer data store; creating a data flow pipeline package, further comprising the steps of: merging the source code, the configuration, and the secrets; and defining a pipeline graph in the first environment pipeline flow registry.

Other systems, methods and features of the present invention will be or become apparent to one having ordinary skill in the art upon examining the following drawings and detailed description. It is intended that all such additional systems, methods, and features be included in this description, be within the scope of the present invention and protected by the accompanying claims.

### BRIEF DESCRIPTION OF THE DRAWINGS

The accompanying drawings are included to provide a further understanding of the invention, and are incorporated in and constitute a part of this specification. The components in the drawings are not necessarily to scale, emphasis instead being placed upon clearly illustrating the principles of the present invention. The drawings illustrate embodiments of the invention and, together with the description, serve to explain the principles of the invention.

FIG. 1 is a block diagram of a first embodiment of an exemplary system for dataflow management.

FIG. 2 is a flowchart of an exemplary embodiment for a computer based method for managing a dataflow pipeline across a plurality of environments.

FIG. 3A is a flowchart of an exemplary embodiment directed to deployment of updated source code into the first environment of FIG. 2.

FIG. 3B is a flowchart of an exemplary embodiment directed to promotion of updated source code into the first environment of FIG. 3A.

FIG. 4A is a flowchart of an exemplary embodiment directed to deployment of updated secret/configuration into the first environment of FIG. 2.

FIG. 4B is a flowchart of an exemplary embodiment directed to promotion of updated secret/configuration into the first environment of FIG. 4A.

FIG. 5 is a schematic diagram illustrating an example of a system for executing functionality of the present invention.

FIG. 6 is a block diagram of a second embodiment of an exemplary system for dataflow management.

### DETAILED DESCRIPTION

The following definitions are useful for interpreting terms applied to features of the embodiments disclosed herein and are meant only to define elements within the disclosure.

As used within this disclosure, “continuous integration” (CI) is a software engineering term referring to the practice of regularly merging working copies of all developers into a shared mainline, for example, several times a day. CI is often intertwined with continuous delivery (CD) or continuous deployment in a CI/CD pipeline. “Continuous delivery” ensures the software checked in on the mainline is always in a state that can be deployed to users and “continuous deployment” makes the deployment process fully automated.

A CI/CD pipeline automates the software delivery process. The pipeline builds code, runs tests (CI), and safely deploys a new version of the application (CD). Automated pipelines remove manual errors, provide standardized feedback loops to developers, and enable fast product iterations.

As used within this disclosure, a “pipeline” (or “Git pipeline,” for instance an Apache Beam Pipeline) refers to an extensible set of tools for modeling build, testing and deploying code. Pipelines are a top-level component of continuous integration, delivery, and deployment. Pipelines include jobs and stages. Pipeline jobs define what to do, for example, compile or test code. Pipeline stages, define when to run the jobs. For example, a pipeline may have four stages, executed in the following order:
A build stage, with a job called compile
A test stage, with two jobs called test1 and test2
A staging stage, with a job called deploy-to-stage
A production stage, with a job called deploy-to-prod

Jobs are executed by runners. Multiple jobs in the same stage are executed in parallel if there are enough concurrent runners. If all jobs in a stage succeed, the pipeline moves on to the next stage. If any job in a stage fails, the next stage is typically not executed, and the pipeline ends early.

As used within this disclosure, “Git” refers to an open-source software used for tracking project changes and revisions across different development teams. Git saves different versions of projects in a folder known as a Git repository (“Git repo”). A Git repository tracks and saves the history of all changes made to the files in a Git project. The Git repository saves this data in a directory called .git, also known as the repository folder. Git uses a version control system to track all changes made to the project (including source code) and saves them in the repository.

As used within this disclosure, a “dataflow” refers to a template configured to allow development teams to share pipelines with team members and across their organization. A dataflow may implement one or more data processing tasks.

As used within this disclosure a “secret” generally refers to secure/sensitive data to be accessed used while processing a pipeline. A secret generally requires some sort of token (e.g., username and password, decryption key, etc.) for access. Such a token may be provided via a resolving entity.

As used within this disclosure, an “environment” refers to one of several spaces where related software systems are maintained. For example, a development environment where software is initially developed, a Quality Assurance (QA) environment where the software is tested in the context of a system before deployment, and a production (prod) environment where the released system operates.

Reference will now be made in detail to embodiments of the present invention, examples of which are illustrated in the accompanying drawings. Wherever possible, the same reference numbers are used in the drawings and the description to refer to the same or like parts.

Embodiments of the present invention are directed towards a dataflow pipeline deployer for real-time modification of software while the software is being run. The system determines what modules of the software are being utilized in the current running of the application and will be utilized in the immediate future, based on the process that is running and associated processes that need to run for the process to be complete. The software only modifies the modules that are not being used currently or will need to be used in the near future. Such modifications may include selective updating of software modules.

The dataflow pipeline deployer manages source code in a Git repo, secrets in secret stores for each of a plurality of environments, a sequencer and specifics for each environment, and a pipeline registry which has a static definition of the pipeline.

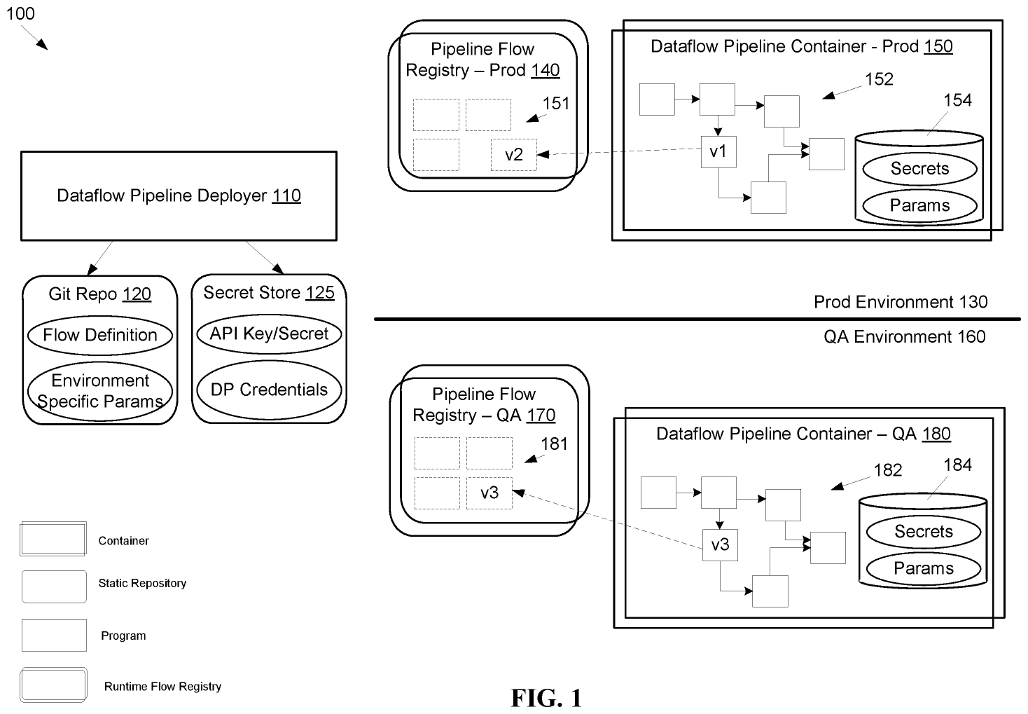

FIG. 1 is a block diagram of an exemplary first embodiment of a system 100 for dataflow management. A dataflow pipeline manager 110 manages pipelines in multiple environments, for example, a production environment 130, a QA environment 160, and a stage environment (not shown). The dataflow pipeline deployer 110 accesses a Git repository 120 of source code and a secret store 125. The Git repository 120 includes flow definitions and environment specific parameters. The secret store 125 may include environment specific API application programming interface (API) keys and/or secrets, as well as environment specific application data pipeline credentials.

In the production environment 130, a production pipeline container 150 contains a production pipeline 152 and a store of secrets and parameters 154. The production pipeline 152 includes a plurality of components (shown as rectangles with solid lines) and flows between the components (shown as solid arrows). A production pipeline flow registry 140 has a static definition 151 of the production dataflow pipeline 152. The dashed boxes represent static definitions of the components of the production dataflow pipeline 152.

The QA environment 160 has a similar structure to the production environment. In the QA environment 160, a QA pipeline container 180 contains a QA pipeline 182 and a store of secrets and parameters 184. The QA pipeline 182 includes a plurality of components (shown as rectangles with solid lines) and flows between the components (shown as solid arrows). A QA pipeline flow registry 170 has a static definition 181 of the QA dataflow pipeline 182. The dashed boxes represent static definitions of the components of the QA dataflow pipeline 182.

The dataflow pipeline manager 110 performs several functions, including (but not limited to):
Managing versioning of data flow definitions in a Git repository 120.
Instantiating and deploying runtime data flow definitions in each environment, for example, the production environment 130 and the QA environment 160.
Checking out runtime data flow definitions to the pipeline container 150.
Managing secrets per environment.
Deploying new versions of secrets and parameters only affecting a subset of the flows, and
Promoting the package to production.

For example, under the first embodiment, a component first version v1 of the production pipeline 152 in the production pipeline container 150 is to be updated by a component second version v2 in the production pipeline flow registry 140. A third version v3 of the component is in the QA pipeline flow registry 170. Once the third version v3 of the component is validated in the QA environment 160, the third version v3 may be promoted to the production environment 150, along with any associated secrets and parameters from the QA dataflow pipeline container 180.

It is desirable for the update to only replace components in the production environment 130 that are affected by the change, thereby only stopping associated portions of the production pipeline 152 while leaving other components operations. Likewise, if the update only involves changing a secret or a parameter, only portions of the production pipeline 152 affected by the change of secret/parameter are stopped. Here, the deployer 110 combines the source code, the secrets/parameters, and the flow definitions.

Under the present embodiments, the definition of a pipeline differs from a traditional Git pipeline. A traditional Git pipeline store source code and run-time definitions. Under the first embodiment the Git pipeline stores source code, dataflow, and secrets as parameters. In a traditional Git pipeline versions are promoted from environment to environment and eventually published. Under the dataflow pipeline embodiments, other components are orchestrated along with source code promotion.

For example, a component to be paused may receive input data from an upstream queue, and provide output data to a downstream queue. In order to pause the component, the upstream queue must similarly be paused while the component is updating, so that data from the upstream queue is not lost during the update.

During the update/promotions, only specifically identified components are paused, refreshed, and then un-paused.

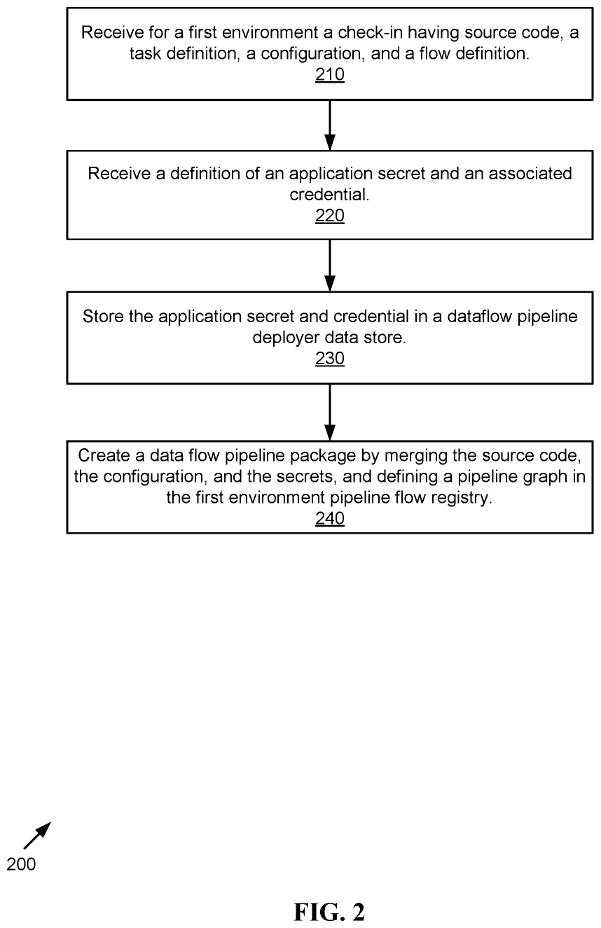

FIG. 2 is a flowchart 200 of an exemplary embodiment for a computer based method for managing a dataflow pipeline across a plurality of environments. It should be noted that any process descriptions or blocks in flowcharts should be understood as representing modules, segments, portions of code, or steps that include one or more instructions for implementing specific logical functions in the process, and alternative implementations are included within the scope of the present invention in which functions may be executed out of order from that shown or discussed, including substantially concurrently or in reverse order, depending on the functionality involved, as would be understood by those reasonably skilled in the art of the present invention.

FIG. 2 is directed to initial deployment of source code into a first environment, for example, a QA environment. The dataflow pipeline deployer receives a check-in, for example, from a development engineer, as shown by block 210. The check-in may include one or more of source code, a task definition, a configuration, and a flow definition. The dataflow pipeline deployer receives a definition of an application secret and an associated credential, for example, from an administrator, as shown by block 220. The dataflow pipeline manager stores the application secret and credential in a dataflow pipeline deployer data store, for example, the secret store 125 (FIG. 1), as shown by block 230. The dataflow pipeline manager creates a data flow pipeline package, as shown by block 240. The Creating the data flow pipeline package may include, for example, merging the source code, the configuration, and the secrets, and defining a pipeline graph in the first environment pipeline flow registry.

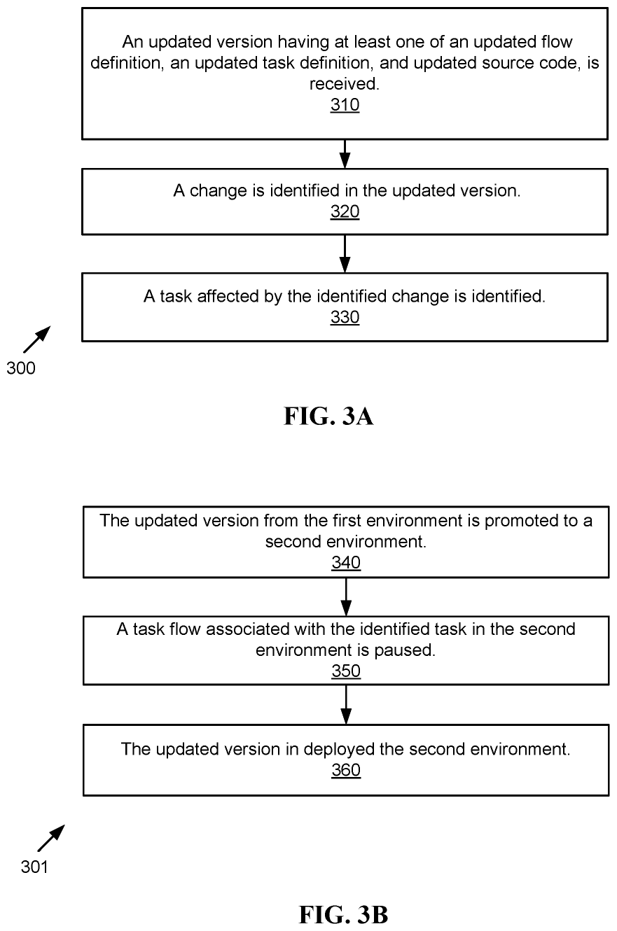

FIG. 3A is a flowchart 300 directed to deployment of updated source code into the first environment. The dataflow pipeline deployer receives an updated version including at least one of an updated flow definition, an updated task definition, an updated configuration, and an updated source code, as shown by block 310. The dataflow pipeline deployer identifies a change in the updated version, as shown by block 320. The dataflow pipeline deployer identifies a task affected by the identified change, as shown by block 330.

After the updated version is verified in the first environment, the dataflow pipeline deployer promotes the updated version to a second environment, for example, a staging environment or a production environment, as shown by the flowchart 301 of FIG. 3B. The updated version is promoted from the first environment to the second environment, for example, a staging or production environment, as shown by block 340. A task flow associated with the identified task in the second environment is paused, as shown by block 350. The updated version is deployed in the second environment, as shown by block 360. Task flows in the second environment not associated with the identified task in the second environment are not paused.

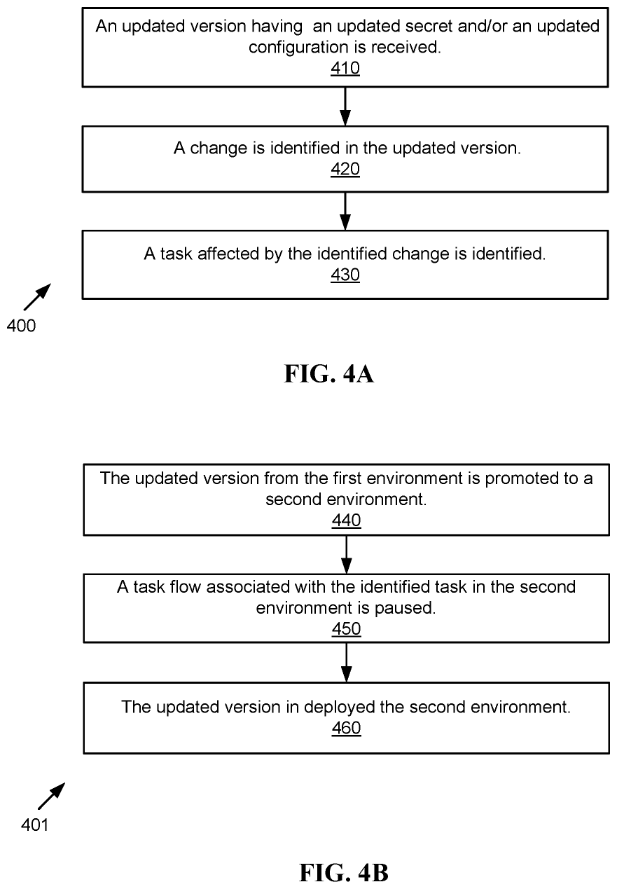

FIG. 4A is a flowchart 400 directed to deployment of an updated secret and/or configuration into the first environment. The dataflow pipeline deployer receives an updated version including an updated configuration and/or an updated secret, as shown by block 410. The dataflow pipeline deployer identifies a change in the updated version, as shown by block 420. The dataflow pipeline deployer identifies a task affected by the identified change, as shown by block 430.

After the updated version is verified in the first environment, the dataflow pipeline deployer promotes the updated version to a second environment, for example, a staging environment or a production environment, as shown by the flowchart 401 of FIG. 4B. The updated version is promoted from the first environment to the second environment, for example, a staging or production environment, as shown by block 440. A task flow associated with the identified task in the second environment is paused, as shown by block 450. The updated version is deployed in the second environment, as shown by block 460. Task flows in the second environment not associated with the identified task in the second environment are not paused.

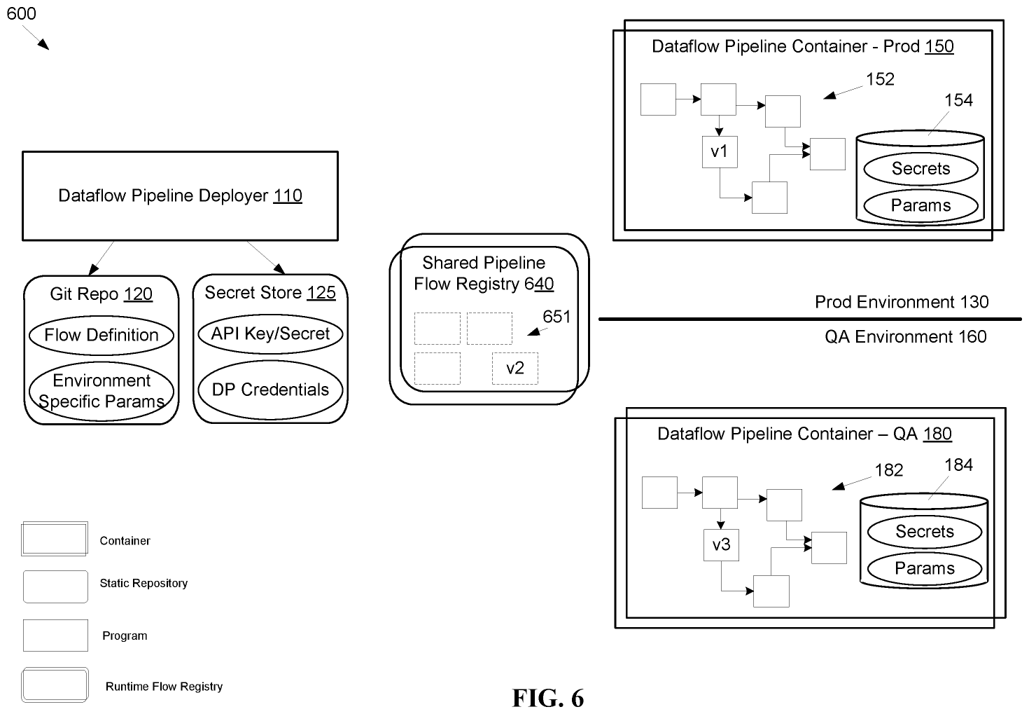

As shown by FIG. 6, under a second embodiment 600 of the present invention, a single pipeline flow registry is shared across two or more environments.

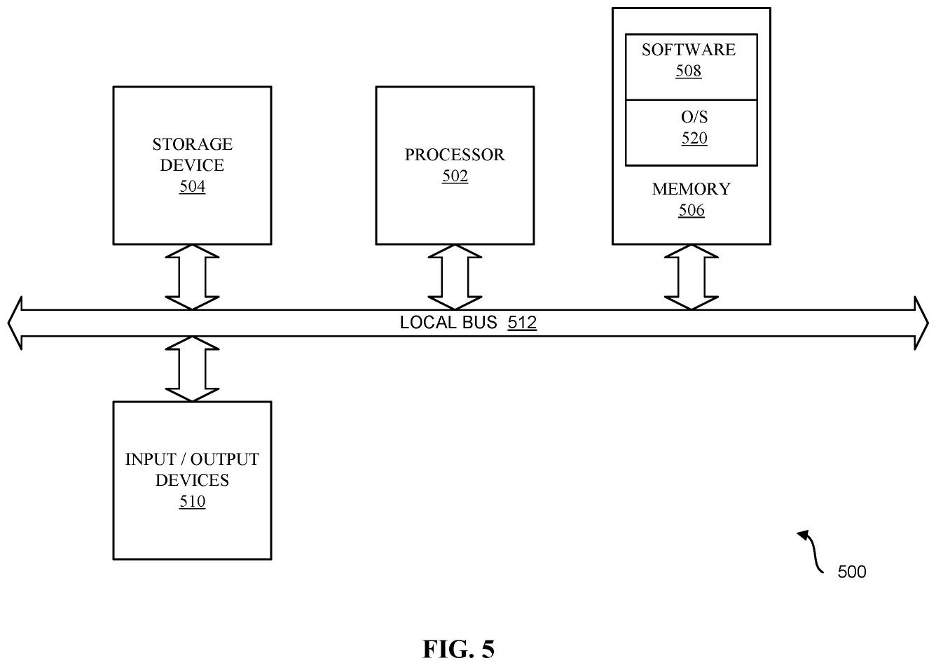

The present system for executing the functionality described in detail above may be a computer, an example of which is shown in the schematic diagram of FIG. 5. The system 500 contains a processor 502, a storage device 504, a memory 506 having software 508 stored therein that defines the abovementioned functionality, input, and output (I/O) devices 510 (or peripherals), and a local bus, or local interface 512 allowing for communication within the system 500. The local interface 512 can be, for example but not limited to, one or more buses or other wired or wireless connections, as is known in the art. The local interface 512 may have additional elements, which are omitted for simplicity, such as controllers, buffers (caches), drivers, repeaters, and receivers, to enable communications. Further, the local interface 512 may include address, control, and/or data connections to enable appropriate communications among the aforementioned components.

The processor 502 is a hardware device for executing software, particularly that stored in the memory 506. The processor 502 can be any custom made or commercially available single core or multi-core processor, a central processing unit (CPU), an auxiliary processor among several processors associated with the present system 500, a semiconductor based microprocessor (in the form of a microchip or chip set), a macroprocessor, or generally any device for executing software instructions.

The memory 506 can include any one or combination of volatile memory elements (e.g., random access memory (RAM, such as DRAM, SRAM, SDRAM, etc.)) and nonvolatile memory elements (e.g., ROM, hard drive, tape, CDROM, etc.). Moreover, the memory 506 may incorporate electronic, magnetic, optical, and/or other types of storage media. Note that the memory 506 can have a distributed architecture, where various components are situated remotely from one another, but can be accessed by the processor 502.

The software 508 defines functionality performed by the system 500, in accordance with the present invention. The software 508 in the memory 506 may include one or more separate programs, each of which contains an ordered listing of executable instructions for implementing logical functions of the system 500, as described below. The memory 506 may contain an operating system (O/S) 520. The operating system essentially controls the execution of programs within the system 500 and provides scheduling, input-output control, file and data management, memory management, and communication control and related services.

The I/O devices 510 may include input devices, for example but not limited to, a keyboard, mouse, scanner, microphone, etc. Furthermore, the I/O devices 510 may also include output devices, for example but not limited to, a printer, display, etc. Finally, the I/O devices 510 may further include devices that communicate via both inputs and outputs, for instance but not limited to, a modulator/demodulator (modem; for accessing another device, system, or network), a radio frequency (RF) or other transceiver, a telephonic interface, a bridge, a router, or other device.

When the system 500 is in operation, the processor 502 is configured to execute the software 508 stored within the memory 506, to communicate data to and from the memory 506, and to generally control operations of the system 500 pursuant to the software 508, as explained above.

When the functionality of the system 500 is in operation, the processor 502 is configured to execute the software 508 stored within the memory 506, to communicate data to and from the memory 506, and to generally control operations of the system 500 pursuant to the software 508. The operating system 520 is read by the processor 502, perhaps buffered within the processor 502, and then executed.

When the system 500 is implemented in software 508, it should be noted that instructions for implementing the system 500 can be stored on any computer-readable medium for use by or in connection with any computer-related device, system, or method. Such a computer-readable medium may, in some embodiments, correspond to either or both the memory 506 or the storage device 504. In the context of this document, a computer-readable medium is an electronic, magnetic, optical, or other physical device or means that can contain or store a computer program for use by or in connection with a computer-related device, system, or method. Instructions for implementing the system can be embodied in any computer-readable medium for use by or in connection with the processor or other such instruction execution system, apparatus, or device. Although the processor 502 has been mentioned by way of example, such instruction execution system, apparatus, or device may, in some embodiments, be any computer-based system, processor-containing system, or other system that can fetch the instructions from the instruction execution system, apparatus, or device and execute the instructions. In the context of this document, a “computer-readable medium” can be any means that can store, communicate, propagate, or transport the program for use by or in connection with the processor or other such instruction execution system, apparatus, or device.

Such a computer-readable medium can be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted, or otherwise processed in a suitable manner if necessary, and then stored in a computer memory.

In an alternative embodiment, where the system 500 is implemented in hardware, the system 500 can be implemented with any or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A computer based method for managing a dataflow pipeline across a plurality of environments, comprising the steps of:
receiving, for a first environment, a check-in comprising source code, a task definition, a configuration, and a flow definition;
receiving a definition of an application secret and an associated credential;
storing the application secret and credential in a dataflow pipeline deployer data store;
creating a data flow pipeline package, further comprising the steps of:
merging the source code, the configuration, and the secrets; and
defining a pipeline graph in the first environment pipeline flow registry.

2. The method of claim 1, further comprising the steps of:
receiving an updated version comprising at least one of the group consisting of an updated flow definition, an updated task definition, an updated configuration, and an updated source code;
identifying a change in the updated version; and
identifying a task affected by the identified change.

3. The method of claim 2, further comprising the steps of:
promoting the updated version from the first environment to a second environment;
pausing a task flow associated with the identified task in the second environment; and
deploying the updated version in the second environment,
wherein task flows in the second environment not associated with the identified task in the second environment are not paused.

4. The method of claim 1, further comprising the steps of:
receiving an updated version comprising at least one of the group consisting of an updated configuration, and an updated secret;
identifying a change in the updated version; and
identifying a task affected by the identified change.

5. The method of claim 4, further comprising the steps of:
promoting the updated secret and/or configuration from the first environment to a second environment;
pausing a task flow associated with the identified task in the second environment; and
deploying the updated version in the second environment,
wherein task flows in the second environment not associated with the identified task in the second environment are not paused.

6. A computer-based software development system (100) configured to deploy a plurality of package environments, comprising:
a processor and storage device configured to store non-transient instructions that when implemented by the processor comprise:
a dataflow pipeline deployer (110);
a Git repository (120) configured to store a flow definition and an environment specific parameter;
a secret store (125) configured to store an API key/secret and data pipeline credentials; and
for each environment of the plurality of environments:
a pipeline flow registry (140, 170) configured to store a static definition (151, 181) of an environment specific production dataflow pipeline (152, 182);
a dataflow pipeline container (150, 180) configured to contain the production dataflow pipeline and a store (154, 184) of environment specific secrets and parameters.

7. A computer based software development system (600) configured to deploy a plurality of package environments, comprising:
a processor and storage device configured to store non-transient instructions that when implemented by the processor comprise:
a dataflow pipeline deployer (110);
a Git repository (120) configured to store a flow definition and an environment specific parameter;
a secret store (125) configured to store an API key/secret and data pipeline credentials;
a pipeline flow registry (640) configured to store static definitions (651) of a plurality of production dataflow pipelines (152, 182); and
for each environment of the plurality of environments:
a dataflow pipeline container (150, 180) configured to contain the production dataflow pipeline and a store (154, 184) of environment specific secrets and parameters.
